(19) United States
(12) Patent Application Publication
(10) Pub. No.: US 2004/0068440 A1
(43) Pub. Date: Apr. 8, 2004

(54) Method for routing electronic messages

(76) Inventor: Marc Porato, Loconville (FR)

Correspondence Address: David D Stein, Boyle Fredrickson Newholm Stein & Gratz, 250 Plaza Suite 1030, 250 East Winconsin Avenue, Milwaukee, WI, 53202, US

(21) Appl. No.: 10/450,481

(22) PCT Filed: Dec. 13, 2001
(86) PCT No.: PCT/FR01/03988

(30) Foreign Application Priority Data
Dec. 13, 2000 (FR) 00/16266

(51) Int. Cl. G06F 17/60

(52) U.S. Cl. 705/14

(57) ABSTRACT

After making to an agreement with a mobile telephony operator (123), an entity (130) may offer his customers the possibility of sending SMS messages free of charge. The sending of messages is then actually subsidized by the entity. A user (101) of this method then indicates his wish to send a message free of charge, and the entity subsidizes the sending of this message along with a second message to the same recipient. The contents of the second message can be chosen by the entity. This second message is composed automatically by the server (123) if it detects a flag, in the message, indicating that a first message is being conveyed through a subsidy from the entity. The conveyance of such messages may be limited in number and time. The contents of the second message are selected from a list that may be updated by the entity.

### BACKGROUND OF THE INVENTION

1. Field of the Invention

An object of the invention is a method for the conveyance of electronic messages. The field of the invention is that of electronic messages traveling on a telecommunications network. The electronic messages are, for example, e-mail type messages or short messages also known as SMS (Short Message Service) messages. The list is not exhaustive. The aim of the invention is to enable an entity to send additional, targeted messages. It is another aim of the invention to enable an entity to propose electronic message transmission services although this is not its main business.

2. Description of the Prior Art

There are mobile telephony operators in the prior art, proposing communication time in return for agreement to being interrupted by advertising messages during calls. The user of such a service therefore takes out a subscription with a mobile telephony operator who proposes these services. The user is assigned a certain number of free minutes of communication. To access the service, he keys in a code and then keys in the telephone number of the person he wishes to call. The code that he keys in indicates his wish to make use of the free telephony service. When the operator receives the connection request, he sends a sound-based advertising message to the user initiating the call. Then, he sets up communication with the person whom the user wishes to contact. During the call, at regular intervals, for example 90-second intervals, the user and his conversation partner are interrupted by sound broadcasts of other advertising messages. This system has two major drawbacks.

The first drawback is that, while it is particularly well suited to direct voice communication, it is not suited to the transmission of electronic messages whose transmission time is very short, often less than one second.

The second drawback is that, if the broadcasting of the additional message reaches both the user who has initiated the conversation and the person answering the telephone, then this mode of broadcasting will cause a disturbance which will hamper the continuance of the conversation. Similarly, it may give rise to a disturbance which may also prevent the additional message from being understood.

In the prior art, it is also known that there are entities that propose the sending of SMS messages free of charge through an Internet site. The principle is that the user can get connected to such an Internet site, compose an SMS message and send it at no cost to himself. However, the sending must be validated by the selection of an advertising strip on the Internet page used to compose the SMS message. The selection of the strip takes him to another site. This other site will then generally present the activities of another entity. Thus, in this example, the sender of the message is obliged to consult another site on the Internet. However, depending on the Internet connection mode, and the state of congestion in the network, it may well happen that the user will never reach this other site, or that he will quite simply interrupt the downloading of this other site. This does not disturb the sending of the SMS message but does not give the desired result, namely the viewing of this other site by the user. Furthermore, it is impossible, by this means, to reach the recipient of the message that has been composed.

Another drawback is that, to be able to benefit from such a system, the user must necessarily have access to the Internet.

### SUMMARY OF THE INVENTION

The invention resolves these problems by enabling a user of the device implementing the method of the invention to compose a first electronic message, enter an identifier of a recipient and validate the message and the identifier by indicating that he wishes to make use of a message-sending service that is free of charge for himself. While it is being conveyed, the composed message is then intercepted by an operator who detects a field in the message corresponding to transmission of a free message. Following this detection, the operator extracts the recipient's identifier from the message and composes a new message for the recipient. This new message corresponds to a message in addition to the message from the person benefiting from the free transmission of the first message. The recipient of the first message will then receive a final message comprising both the first message and an additional message from the entity subsidizing the transmission of the message. This composing of the message takes place following an agreement between the operator and an entity who subsidizes the transmission of these messages.

In one variant, the recipient can also receive two messages, one comprising the first composed message and a second message comprising the additional message from the entity subsidizing the sending of the message.

When he composes the second additional message, the operator also updates counters used to prepare records of the number of messages per sender and per supplier of additional messages.

In one variant, the first message, namely the one composed by the user, is addressed to a server dedicated to the sending of subsidized messages. In this case, it is no longer necessary to have recourse to a field indicating the sending of a subsidized message, since the sole fact of sending a message to this server means that it is a transmission of a subsidized message. In this variant, the composed message comprises an identifier of the final recipient of the message. This identifier may be a telephone number, an electronic address or any other known reference of the server. The server then carries out the above-mentioned management operations for the composing of the additional message.

An object of the invention, therefore, is a method for the conveying of electronic messages wherein:

a first electronic message is composed,

an identifier of a recipient is entered,

the message and the identifier are validated,

the first message is conveyed to the apparatus identified by the identifier through a network,

wherein:

the identifier of the recipient is retrieved during conveyance if information is entered in an interception flag,

a second electronic message is produced,

the second message is conveyed to an apparatus identified by the identifier through a network.

### BRIEF DESCRIPTION OF THE DRAWINGS

The invention will be understood more clearly from the following description and the accompanying figures. The figures are given purely by way of an indication and in no way restrict the scope of the invention. Of these figures:

FIG. 1a illustrates means useful for implementing the method according to the invention;

FIG. 1b illustrates the structure of an electronic message;

FIG. 2a illustrates steps of the method according to the invention;

FIG. 2b illustrates steps of the method according to a variant of the invention;

### MORE DETAILED DESCRIPTION

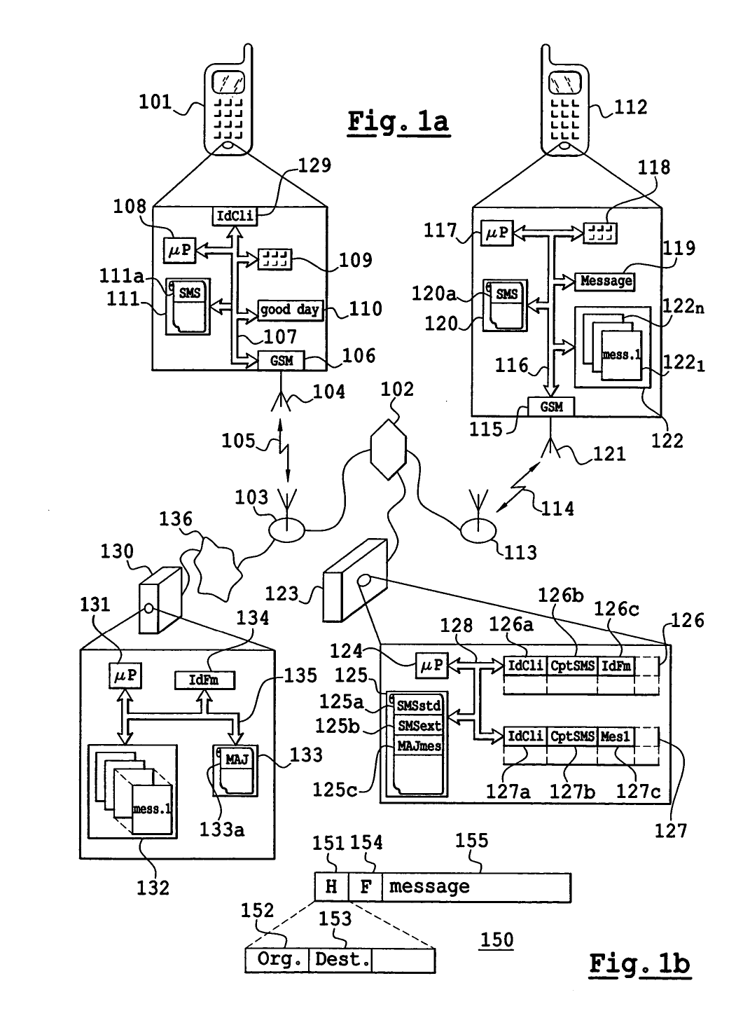

FIG. 1 shows a mobile telephone 101 connected to a GSM network 102. In the present description, an electronic message is deemed to be exchanged between two mobile telephones working according to the GSM standard. However, the description is still valid if the telephony standard is not the GSM standard but the UMTS standard, the IMT 2000 standard or any other standard. Similarly, the description remains valid if it is an e-mail message exchanged between two PCs connected to the Internet, or an SMS message exchanged with a PC, connected to the Internet and then to the GSM network, and a mobile telephone of this GSM network.

The telephone 101 is connected to the network 102 through a base station 103 of the network 102. The telephone 101 therefore has an antenna 104 enabling a wireless link 105 to be set up with the station 103. The antenna 104 is furthermore connected to GSM circuits 106. The role of the circuits 106 is firstly to process analog signals received by the antenna 104 in order to produce digital signals and, secondly, to produce modulated analog signals from the digital signals received through a bus 107. A bus is a set of films or tracks comprising these elements in a number sufficient to convey address, command, data, clock, interruption and power supply signals.

The telephone 101 also has a microprocessor 108, a keyboard 109, a screen 110 and a memory 111. The elements 108 to 111 are connected to the bus 107. The telephone 101 is described functionally in order to enable a clearer understanding of the implementation of the method according to the invention. Thus the microprocessor 108 performs a certain number of tasks controlled by instruction codes recorded in a zone of the memory 111. Thus the memory 111 has a zone 111a that controls the microprocessor 108 when the telephone 101 has an activity related to the sending or reception of the SMS message. The keyboard 109 enables a user of the telephone 101 to enter an electronic message, enter an identifier and validate both the message and the identifier, thus causing the composed message to be sent. The sending is then done through the circuit 106 and the antenna 104. The screen 110 is used to display the message that the user of the telephone 101 is composing or has received. This is one of several uses of the screen 110 and keyboard 109.

The telephone 101 also has an identifier memory 129. This memory comprises a code that enables the operator to identify the customer using the telephone 101. This identifier is, for example, a telephone number of the user, or the number of a SIM (Subscriber Identifier Module) card.

FIG. 1a shows a second mobile telephone 112 connected to the network 102 through a base station 113 and a wireless link 114. The telephone 112 has elements 115 to 120 respectively identical in their function to the elements 106 to 111 respectively, described here above. The GSM circuits 115 are connected to an antenna 121 enabling the wireless link 114 to be set up. The telephone 112 also has a memory 122 connected to the bus 116. The memory 122 is a memory of SMS type received messages. This memory also exists in the telephone 101 but has not been shown because, in this example, the telephone 101 is considered to be the message-sending apparatus and the telephone 112 is the message-receiver apparatus. The memory 122 has a certain number of messages numbered 122.1 to 122.n.

As a general rule, these messages are SMS messages. However, in one variant of the invention, the memory 122 could also have e-mail messages. It is indeed possible to receive and send e-mail messages from a mobile telephone.

FIG. 1a also shows a server 123 connected to the network 102. In a preferred example, the server 123 is deemed to be managed by an operator who implements the GSM network 102. The server 123 has a microprocessor 124, a program memory 125, the memory 126 for the management of the customers of the operator managing the server 123, and a suppliers' memory 127. The memory 127 enables the operator to manage a relationship with suppliers of additional messages. These suppliers of additional messages are those who subsidies the sending of SMS messages by the method according to the invention. The elements 124 to 127 are connected by a bus 128. The server 123 also has means to get connected to various networks, such as the GSM network 102 or the Internet 136. These means are known and are not represented in order to avoid burdening the drawing. The memory 125 has, inter alia, instruction codes controlling the microprocessor 124 during its various activities. In particular, the memory 125 has a zone 125a comprising instruction codes that control the microprocessor 124 when it carries out standard management of the SMS messages, a zone 125b when the microprocessor 124 carries out extended management of the SMS messages, namely management according to the method of the invention, and a zone 125c that commands the microprocessor 125 during an updating of additional messages, i.e. an updating of the memory 127. The memory 126 is divided into several rows and several columns. The structure that will be described is only one example by which the information referred to can be structured. In the example, each row corresponds to a customer of the telephony operator managing the server 123. Each column corresponds to a piece of information on this customer. A first column 126a has an identifier of the customer. A second column 126b has a counter used to count up the number of messages that the customer has sent using the method according to the invention. In one variant of the invention, the memory 126 also has a zone 126c comprising an identifier of a supplier of additional messages. This identifier corresponds to the supplier who subsidizes the sending of the customer's SMS messages. Another of these fields, not shown, is for example a maximum number of SMS messages that the customer may send through the method of the invention. There are other fields supplying other information on customers but these fields are not relevant to the method according to the invention.

The memory 127 is structured, for example, in the same way as the memory 126. Each row of the memory 127 corresponds to a supplier of additional messages. The memory 127 has a first column 127a comprising an identifier of the message supplier. The second column 127b comprises the total number of SMS messages that the supplier has hitherto subsidized. The columns 127a to 127n comprise additional messages that the supplier of additional messages wishes to have inserted in the SMS messages whose transmission he is subsidizing.

In the example chosen, the memories 126 and 127 have a single-table structure. In practice, the data recorded in these tables, 126 and 127 may be distributed over a larger number of tables. This is especially the case in a relational database for example. In FIG. 1a, all the memories of a given apparatus are represented in a discrete and exploded view. Physically, all these memories may be several zones of a huge memory made by means of only one electronic component or else several electronic components.

FIG. 1a shows that the server 123 is connected to a server 130 through the Internet 136. The server 130 is, for example, a server of a message supplier. A supplier of additional messages is, for example, an entity who has made an agreement with a telephony operator to carry out advertising activities. The supplier of additional messages therefore subsidizes the dispatch of SMS messages in return for the insertion, into the SMS messages, of information of interest to the supplier of additional messages, or the sending of other SMS messages comprising such information. Thus, the supplier of additional messages may offer his customers the possibility of sending SMS messages free of charge through an operator with whom the supplier has an agreement. The customer, or target, of the supplier of additional messages therefore also becomes the customer of the mobile telephony operator, except that the fees that have to be paid in order that he may become a customer of the telephony operator are borne by the supplier of additional messages.

The server 130 has a microprocessor 131, a message memory 132, a program memory 133 and an identifier memory 134. The elements 131 to 134 are connected to a bus 135. The server 130 also has means to get connected to the Internet 136. These means are known and are not shown. The memory 133 has a zone 133a comprising instruction codes that control the microprocessor 131 when the server 130 is in communication with the server 123 in order to update the contents of the message memory 127. The memory 132 contains additional messages that the suppliers of additional messages wish to insert into the SMS messages that they subsidies. During an updating of the messages, the memory 132 messages are transferred into an appropriate zone of the memory 127 of the server 123.

FIG. 1b shows a structure of an SMS message 150 according to the invention. A message 50, like all SMS messages, has a header 151. The header 151 has at least one identifier 152 of the sender of the message and an identifier 153 of the recipient of the message. In the invention, the header is followed by a flag field 154 indicating that this message is being sent thanks to a subsidy from a supplier of messages. The field 154 is followed by the body 155 of the message. In the case of the sending of an e-mail message, the structure of the message is the same. Indeed, an e-mail message has identifiers of the sender, the recipient and a certain number of fields which may be re-used to make the flag.

The flag field may comprise a predefined code, or telephone number. In particular, if we envisage an embodiment with a dedicated server, the flag field may then contain a telephone number of the final recipient of the message which is sent directly to the dedicated server.

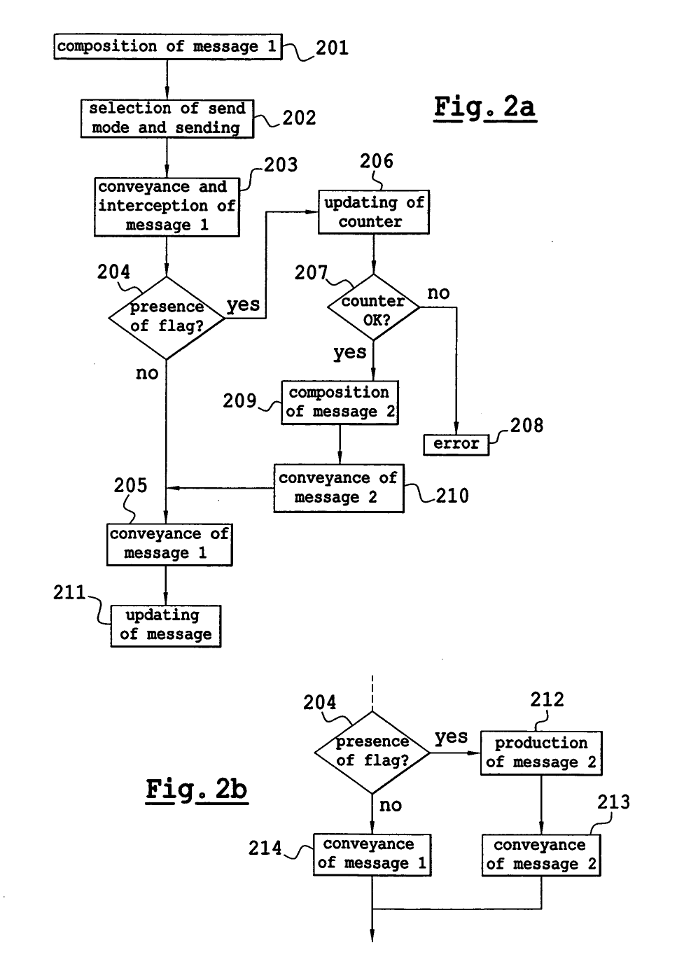

FIG. 2a shows a preliminary step 201 for the composing of a first message. In the step 201, the user of the telephone 101 uses the keyboard 109 to compose a message. In this example, it is an SMS message. This message therefore has a maximum of 140 alphanumerical characters. In one variant of the invention, the user of the telephone 101 may first of all have to enter a flag corresponding to the field 154 of FIG. 1b . In one example, the flag is the code that can be used to identify the supplier of additional messages who subsidizes the sending of this SMS message. The flag may also be a single predetermined code. In another variant of the invention, this flag is automatically inserted into the message at the time of the validation and sending of the message. In one variant with a dedicated server, the server retrieves the final address of the message, and the address of the server is used by the telephone 101 to send the message.

Before or after having composed the message, the user of the telephone 101 uses the keyboard to enter an identifier of the recipient of the message. The identifier of the recipient is, for example, a number of a telephone of the recipient.

The user of the telephone 101 follows the running of these operations of composition and entry on the screen 110. The operation passes to a step 202 for the selection of the sending mode, and for the sending proper of the message. In the step 202, the user chooses between having the message that he has just composed sent through a subsidy by a supplier of additional messages and having it sent through his own telephone subscription. This selection can be made either by the manual insertion of a flag in the message or by the mode of validation of the send operation. For example, there may be a validation key for the send operation using his own telephone subscription, and a validation key for the send operation making use of a supplier of additional messages. These two keys are then parametrized beforehand by the user of the telephone 101. The mode of sending may also be selected through a menu of the mobile telephone. In the case of a dedicated server, the fact that the address to which the message is sent is the address of the dedicated server is enough to determine the mode.

Once the validation is done, the operation passes to a step 203 for the conveyance and interception of the first message. Here, the term “interception” is used chiefly to designate the step 203. In practice, the message is not really intercepted, but undergoes additional processing during its conveyance. In the step 203, the sending has been validated by the user of the telephone 101. The message is then conveyed up to the server 123 through the circuits 106, the link 105, and the network 102. The microprocessor 124, controlled by the instruction codes of the zone 125a, detects the arrival of an SMS message. In this SMS message, the microprocessor 124 detects the presence or absence of a flag. This is the step 204 of searching for the flag. The conveyance of an SMS message by a mobile telephony operator is a known method. In the invention, the difference appears with the processing that the operator carries out on the SMS message while it is being conveyed.

In the step 204 the microprocessor 124, controlled by the instruction codes of the zone 125a, scans all the SMS messages conveyed by the server 123, in search of a flag, if any, indicating that the sending of the SMS message is being subsidized by a supplier of additional messages. If this flag is not detected, the operation passes to a step 205 for conveying the message 1.

In the step 205, the first message is conveyed to its recipient in a known way. The message is received in the telephone 112 and recorded in the memory 122 . The user of the telephone 112 can then display and/or erase the message. These actions can be performed by means of the keyboard 118 and the screen 119. These actions are performed under the control of the microprocessor 117 controlled by instruction codes of the zone 120a of the memory 120.

If, in the step 204, a flag is detected, then the operation passes to a step 206 for updating the counter.

In the step 206, the microprocessor 124 has detected the presence of a flag indicating that the sending of this message is taken charge of by a supplier of additional messages. The microprocessor 124 is then commanded by instruction codes of the zone 125b for the management of the SMS messages in extended mode. The term “extended mode” is used with reference to the normal mode of conveyance of an SMS message. The microprocessor 124 extracts the identifier of the sender of the SMS message from the header of the SMS message. The microprocessor searches for this identifier in the table 126. Once it has found the identifier, it increments the counter 126b, corresponding to the number of subsidized SMS messages sent, by one unit. The operation then passes to a step 207 for testing the counter.

The step 207 is optional and depends on an agreement existing between the mobile telephony operator and the supplier of additional messages. This agreement may stipulate that the customers of the mobile telephony operator are entitled to a limited number of SMS message sending operations. In this case, in the step 207, the microprocessor 124 checks whether the new value of the counter is really lower than the number of SMS to which a customer user is entitled. If this number is greater than the number of messages to which the customer is entitled, the operation passes to an error step 208.

In the step 208, the operator interrupts the conveyance of the first message and, as the case may be, sends a message to the user of the telephone 101 to inform him that, for this time period, he can no longer resort to sending subsidized SMS messages. Indeed, in general, offers of free SMS messaging services cover a certain set number of SMS messages per period.

In the step 207, if the user of the telephone 101 is entitled to send a subsidized SMS message, the operation passes to a step 209 for composing the second message. In the step 209, either the flag included in the first SMS message is an identifier of a supplier of additional messages, or it is necessary to resort to the contents of the field 126c corresponding to the sender of the SMS message. If the flag is not an identifier of a supplier, the field read is the field 126c of the row previously identified during the search for the identifier, in the table 126, of the sender of the first message. The field 126c then identifies a supplier of additional messages subsidizing the user's SMS messages.

Once the microprocessor 124 is in possession of the identifier of the supplier of additional messages, it makes a search for this identifier in the table 127. Once the microprocessor has found the identifier in the table 127 it increments the counter corresponding to this identifier in order to account for the number of SMS messages subsidized by this supplier of additional messages. Then the microprocessor selects a message from among all the messages corresponding to this supplier of messages. This selection can be made randomly for example. This selection is made in the table 127, in the row corresponding to the previously identified supplier of messages. Once a message is selected, the microprocessor 124 composes a second SMS message. This second SMS message has a header in which the sender identifier is, for example, the identifier of the sender of the first SMS message, and in which the recipient identifier is that of the recipient of the first SMS message. The messages included in the table 127 are, for example, advertisements messages for the entity subsidizing the sending of the messages.

This second message does not have any flag, and the body of the message of this second message corresponds to the additional message that has just been selected. The operation then passes to a step 210, similar to the step 205, for conveying the second message. This step 210 follows a traditional mode of conveyance of SMS messages.

From the step 210, the operation then passes to the step 205. In this variant of the invention, the recipient of the first SMS message receives two messages. A first SMS message composed by the user of the apparatus 101 and a second SMS message automatically composed by the server 123 at the request of the supplier of additional messages. The fees corresponding to the conveyance of these two SMS messages are then paid for by the supplier of additional messages.

From the step 205, the operation passes to a step 211 for updating the list of messages.

In the step 211, the microprocessor 131, controlled by instruction codes of the zone 133a composes, for example, an e-mail message. This email message has an identifier of additional message suppliers, namely the contents of the memory 134, and a list of messages corresponding to the messages recorded in the memory 132. This e-mail message also has an instruction code indicating that it is a list of messages enabling the updating of the additional messages used to produce second messages. Once this e-mail message has been composed, it is sent through the network 136 to the server 123. When the server 123 receives this e-mail message, it detects the presence, in this e-mail message, of the instruction code indicating the wish of the supplier of additional messages to update the list of additional messages. The microprocessor 124, controlled by instruction codes of the zone 125b, then extracts the additional messages from this e-mail message and uses them to carry out the replacement, in the memory 127, of the additional messages corresponding to the supplier of messages identified by the identifier contained in the e-mail message.

FIG. 2b describes a variant of the invention. FIG. 2b shows the step 204. From the step 204, the operation then passes to a step 212 for the production of the second message. The step 212 is identical to the step 209 except that, instead of inserting the contents of the second message in a new SMS message, it is inserted after the first SMS message in the same SMS message. The operation then passes to the step 213 for conveying the second message.

If there is no flag, the operation passes from the step 204 to a step 214 for conveying the first SMS message. From the steps 213 and 214, the operation passes to the step 211. The steps 213 and 214 are similar to the step 205.

In this variant, it can be seen that if there is a flag present in the first message, it is no longer conveyed as it is. The recipient of the first message will therefore receive a message constituted by the body of the first message and the additional message. This variant enables the sending of only one message. However, since an SMS message is limited to 140 characters, this variant also limits the number of characters that can be used both by the user of the telephone 101 and the supplier of additional messages to compose their messages. However, this limitation should disappear with the progress of mobile telephony. For the time being, this variant is more interesting when sending e-mail messages that are not limited in size. In any case, this variant is valuable because it provides greater probability that the additional message will be read.

The variant of FIG. 2b, shows only the steps equivalent to the steps 206 to 208. However, these steps exist in this variant and are located, for example, between the step 204 and the step 212.

In a server variant of the invention, the composition of the additional message is done by a server dedicated to this use. In this case, the step 204 is superfluous since the simple fact of addressing a message to the server means that the sending of this message is subsidized. Thus, in the server variant, the operation passes from the step 203 to the step 206. It is no longer necessary that there should be a flag field in the message. However, this field is replaced by an identifier of the final recipient, for example a telephone number or an electronic address. This identifier is used to reroute the first and second messages. In the server variant, it is possible to envisage a mode with two messages, a first message that is composed and a second additional message. It is also possible to envisage a mode with only one message comprising the contents of the first message and the contents of the additional message. These two modes actually correspond to modes respectively described for FIGS. 2a and 2b respectively.

In one server variant, the message composed by the user therefore has a header, comprising an identifier of the user and an identifier of the intermediate recipient, namely the server, a field comprising an identifier of the final recipient, and a message. The final recipient is actually a person to whom a user, enjoying the benefit of a subsidy, may wish to send a first message.

In the server variant, the structure of the dedicated server is similar to the one described for the server 123. This server has an address on the network used for dispatching first messages. It is this address that is used as an intermediate recipient during the composition of the first message.

In one variant of the invention, the apparatus receiving the additional message comprises means to get connected to an Internet type network. In the case of a mobile telephone, this is for example a WARP (Wireless Application Protocol) navigator. In the case of a personal computer, it is for example an Internet navigator. It is therefore possible to include Internet addresses or links in the additional message. It is even possible to include a page in WML (Wireless Markup Language) or HTML (Hyper Text Markup Language) in the additional message, depending on whether it is an SMS message or an electronic message.

Thus, on his telephone, the final recipient of the composed message receives either an address enabling him to get connected to an Internet site of the entity having subsidized the sending of the message. The recipient can then choose to get connected to the site and visit it.

Or else the recipient receives a WML message which he can view on his telephone. A WML page is the equivalent of an HTML page. WML and HTML are respectively two description languages enabling multimedia presentation on a screen of a mobile telephone or personal computer respectively. These two languages are used with reference to the Internet.

The server 123 of the dedicated server is capable of producing a balance sheet of the additional messages that have been sent. This balance sheet is produced by means of a scanning of the memory 126 and 127 by the microprocessor 124. During this scanning, the microprocessor totalizes the additional messages per supplier of additional messages. Indeed, each customer of the memory 126 has a corresponding supplier of the memory 127 through the column 126c. This means that all that needs to be done is to totalize the contents of the fields 126b for each supplier. Thus, each supplier can assess the impact of his subsidies.

In one variant, in the step 206, the number of messages is counted up, not per user but only per supplier of additional messages. This simplifies the production of balance sheets. It is no longer necessary to make a joint scanning of the memories 126 and 127. However, it reduces the precision of the management of additional messages because then less information is available on their use.

What is claimed is:

1- A method for the conveying of electronic messages wherein:
a first electronic message is composed,
an identifier of a recipient is entered,
the message and the identifier are validated,
the first message is conveyed to the apparatus identified by the identifier through a network,
wherein:
the identifier of the recipient is retrieved during conveyance if information is entered in an interception flag,
a second electronic message is produced,
the second message is conveyed to an apparatus identified by the identifier through a network.

2- A method according to claim 1, wherein the second message comprises the first message and an additional part, the first message, as composed, being then not conveyed up to the recipient.

3- A method according to one of the claims 1 or 2, wherein the first message comprises a field to indicate that the identifier of the recipient of this message can be retrieved in order to produce the second message.

4- A method according to one of the claims 1 to 3, wherein the first message is conveyed through a first dedicated server whose address is used as an intermediate recipient, to compose the second message.

5- A method according to one of the claims 1 to 4, wherein a count is made of the number of second messages produced per first message sender identifier.

6- A method according to claim 5, wherein a record is produced, per message contents supplier, of the second messages produced from a table of correspondence between second message contents suppliers and first message sender identifiers, and the result of the counting.

7- A method according to one of the claims 1 to 5, wherein a record is produced, per message contents supplier, of the second messages produced.

8- A method according to one of the claims 1 to 7, wherein the first and second messages are of a same nature, preferably electronic mail or SMS message.

9- A method according to one of the claims 1 to 8, wherein the first and second messages are of different natures, preferably electronic mail and SMS message or vice versa.

10- A method according to one of the claims 1 to 9, wherein the second message is produced as a function of a message table and an identifier of the sender of the first message.

11- A method according to claim 10, wherein the contents of the message table are updated.

12- A method according to one of the claims 1 to 11, wherein the second message is composed in incorporating a link to an Internet site therein.

13- A method according to one of the claims 1 to 12, wherein a second message is composed in using a description language of presentation adapted to the medium receiving the second message.
